(19) United States
(12) Patent Application Publication
(10) Pub. No.: US 2025/0358684 A1
(43) Pub. Date: Nov. 20, 2025

(54) SCALABILITY PARAMETERS FOR PDU SET TRAFFIC

(71) Applicant: QUALCOMM Incorporated, San Diego, CA (US)

(72) Inventors: Sitaramanjaneyulu KANAMARLAPUDI, San Diego, CA (US); Diana MAAMARI, San Diego, CA (US); Linhai HE, San Diego, CA (US)

(21) Appl. No.: 19/180,608

(22) Filed: Apr. 16, 2025

Related U.S. Application Data
(60) Provisional application No. 63/649,746, filed on May 20, 2024.

(51) Int. Cl. H04W 28/18

(52) U.S. Cl. CPC H04W 28/18

(57) ABSTRACT

Methods, systems, and devices for wireless communications are described. A UE may receive a first message indicating a packet data unit (PDU) set configuration for a PDU set. The PDU set configuration may indicate a parameter associated with the PDU set, a scalability parameter associated with the parameter, and a scaling trigger condition for applying the scalability parameter to the parameter. The UE may apply the scalability parameter to the parameter to obtain a scaled parameter based on the scaling trigger condition being satisfied. The UE may transmit, based at least in part on the scaled parameter satisfying a threshold, a second message associated with the PDU set.

### CROSS REFERENCES

The present Application for Patent claims benefit of U.S. Provisional Patent Application No. 63/649,746 by KANAMARLAPUDI et al., entitled “SCALABILITY PARAMETERS FOR PDU SET TRAFFIC,” filed May 20, 2024, assigned to the assignee hereof, and expressly incorporated herein.

### TECHNICAL FIELD

The following relates to wireless communications, including scalability parameters for PDU set traffic.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein. A method for wireless communications by a user equipment (UE) is described. The method may include receiving a first message indicating a packet data unit (PDU) set configuration for a PDU set, where the PDU set configuration indicates a parameter associated with the PDU set, a scalability parameter associated with the parameter, and a scaling trigger condition for applying the scalability parameter to the parameter, applying the scalability parameter to the parameter to obtain a scaled parameter based on the scaling trigger condition being satisfied, and transmitting, based on the scaled parameter satisfying a threshold, a second message associated with the PDU set.

A UE for wireless communications is described. The UE may include one or more memories storing processor executable code, and one or more processors coupled with (e.g., operatively, communicatively, functionally, electronically, or electrically) the one or more memories. The one or more processors may individually or collectively be operable to execute the code (e.g., directly, indirectly, after pre-processing, without pre-processing) to cause the UE to receive a first message indicating a PDU set configuration for a PDU set, where the PDU set configuration indicates a parameter associated with the PDU set, a scalability parameter associated with the parameter, and a scaling trigger condition for applying the scalability parameter to the parameter, apply the scalability parameter to the parameter to obtain a scaled parameter based on the scaling trigger condition being satisfied, and transmit, based on the scaled parameter satisfying a threshold, a second message associated with the PDU set.

Another UE for wireless communications is described. The UE may include means for receiving a first message indicating a PDU set configuration for a PDU set, where the PDU set configuration indicates a parameter associated with the PDU set, a scalability parameter associated with the parameter, and a scaling trigger condition for applying the scalability parameter to the parameter, means for applying the scalability parameter to the parameter to obtain a scaled parameter based on the scaling trigger condition being satisfied, and means for transmitting, based on the scaled parameter satisfying a threshold, a second message associated with the PDU set.

A non-transitory computer-readable medium storing code for wireless communications is described. The code may include instructions executable by one or more processors (e.g., directly, indirectly, after pre-processing, without pre-processing) to receive a first message indicating a PDU set configuration for a PDU set, where the PDU set configuration indicates a parameter associated with the PDU set, a scalability parameter associated with the parameter, and a scaling trigger condition for applying the scalability parameter to the parameter, apply the scalability parameter to the parameter to obtain a scaled parameter based on the scaling trigger condition being satisfied, and transmit, based on the scaled parameter satisfying a threshold, a second message associated with the PDU set.

Some examples of the method, UEs, and non-transitory computer-readable medium described herein may further include operations, features, means, or instructions for receiving an indication of a network congestion state associated with a wireless channel, where the network congestion state indicates that the scaling trigger condition may be satisfied.

In some examples of the method, UEs, and non-transitory computer-readable medium described herein, the scaling trigger condition may be satisfied based on a PDU set metric associated with the PDU set exceeding a PDU set threshold.

In some examples of the method, UEs, and non-transitory computer-readable medium described herein, the PDU set metric includes a delay status report trigger associated with a delay budget of the PDU set, a data traffic volume associated with the PDU set, or both.

Some examples of the method, UEs, and non-transitory computer-readable medium described herein may further include operations, features, means, or instructions for monitoring an error rate associated with transmission of one or more packets, where the error rate exceeding an error rate threshold indicates that the scaling trigger condition may be satisfied.

Some examples of the method, UEs, and non-transitory computer-readable medium described herein may further include operations, features, means, or instructions for monitoring one or more retransmissions of one or more packets of the PDU set, where a quantity of retransmissions exceeding a retransmission threshold indicates that the scaling trigger condition may be satisfied.

Some examples of the method, UEs, and non-transitory computer-readable medium described herein may further include operations, features, means, or instructions for applying a second scalability parameter to the parameter to obtain a second scaled parameter based on a second scaling trigger condition being satisfied and transmitting, based on the second scaled parameter satisfying a second threshold, a third message associated with the PDU set.

In some examples of the method, UEs, and non-transitory computer-readable medium described herein, the PDU set includes a set of multiple PDUs that may be each associated with a jitter metric.

Some examples of the method, UEs, and non-transitory computer-readable medium described herein may further include operations, features, means, or instructions for receiving, based on transmission of the second message, a resource grant associated with the PDU set and transmitting one or more packets data units of the PDU set via a resource allocated by the resource grant.

Some examples of the method, UEs, and non-transitory computer-readable medium described herein may further include operations, features, means, or instructions for monitoring a key performance indicator (KPI) associated with the PDU set, wherein the KPI exceeding a KPI threshold indicates that the scaling trigger condition is satisfied.

Some examples of the method, UEs, and non-transitory computer-readable medium described herein may further include operations, features, means, or instructions for monitoring a ratio between a grant pattern and an actual data rate associated with transmission of one or more packets, wherein the ratio exceeding a ratio threshold indicates that the scaling trigger condition is satisfied.

In some examples of the method, UEs, and non-transitory computer-readable medium described herein, application of the scalability parameter is based at least in part on an output of a machine learning (ML) model, and wherein an input of the ML model comprises the scalability parameter and an indication of one or more channel conditions.

In some examples of the method, UEs, and non-transitory computer-readable medium described herein, the second message includes a polling message associated with the PDU set, a status message associated with the PDU set, or a buffer status request (BSR) message associated with the PDU set.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports scalability parameters for PDU set traffic in accordance with one or more aspects of the present disclosure.

FIG. 2 shows an example of a wireless communications system that supports scalability parameters for PDU set traffic in accordance with one or more aspects of the present disclosure.

FIG. 3 shows an example of a PDU session flow that supports scalability parameters for PDU set traffic in accordance with one or more aspects of the present disclosure.

FIG. 4 shows an example of a wireless communications system that supports scalability parameters for PDU set traffic in accordance with one or more aspects of the present disclosure.

FIG. 5 shows an example of a process flow that supports scalability parameters for PDU set traffic in accordance with one or more aspects of the present disclosure.

FIGS. 6 and 7 show block diagrams of devices that support scalability parameters for PDU set traffic in accordance with one or more aspects of the present disclosure.

FIG. 8 shows a block diagram of a communications manager that supports scalability parameters for PDU set traffic in accordance with one or more aspects of the present disclosure.

FIG. 9 shows a diagram of a system including a device that supports scalability parameters for PDU set traffic in accordance with one or more aspects of the present disclosure.

FIGS. 10 through 12 show flowcharts illustrating methods that support scalability parameters for PDU set traffic in accordance with one or more aspects of the present disclosure.

### DETAILED DESCRIPTION

In some wireless communications systems, a user equipment (UE) may receive a packet data unit (PDU) set from a network entity. The PDU set may include a plurality of PDUs associated with common jitter metrics (e.g., jitter requirements). The network entity may configure the UE with one or more parameters (e.g., radio link control (RLC) polling or status and medium access control (MAC) buffer status report (BSR) configuration triggers, timers, and counters) associated with transmitting a polling or request message at the UE. For example, the UE may transmit a polling message based on a parameter (e.g., latency parameter) satisfying a threshold. The parameters, however, may not update dynamically based on PDU set metrics or network conditions. In some cases, the parameters (e.g., timers) may be configured too high to satisfy PDU set metrics. In some cases, the parameters may not adapt based on a congestion state of the network. The pre-configured parameters may increase latency at the UE and decrease efficient use of communication resources.

According to techniques described herein, the UE may receive an indication of a PDU set configuration for a PDU set. The PDU set configuration may include one or more parameters and a scalability parameter associated with the one or more parameters. The UE may monitor a set of one or more scaling trigger conditions associated with the application of the scalability parameter. The UE may apply the scalability parameter to one or more parameters based on a scaling trigger condition of the set of one or more scaling trigger conditions satisfying a threshold. For example, the UE may apply a scalability parameter to the parameters based on a congestion state indication through downlink MAC control element (MAC-CE). In some examples, the scalability parameter may increase or decrease a parameter by a given percentage. The UE may transmit a control message based on a parameter satisfying a threshold in accordance with the scalability parameter. The scalability parameter may decrease latency and improve efficient use of communication resources by providing dynamic adaptation of network configured parameters.

Aspects of the disclosure are initially described in the context of wireless communications systems. Additional aspects of the disclosure are described in the context of PDU session flows and process flows. Aspects of the disclosure are further illustrated by and described with reference to apparatus diagrams, system diagrams, and flowcharts that relate to scalability parameters for PDU set traffic.

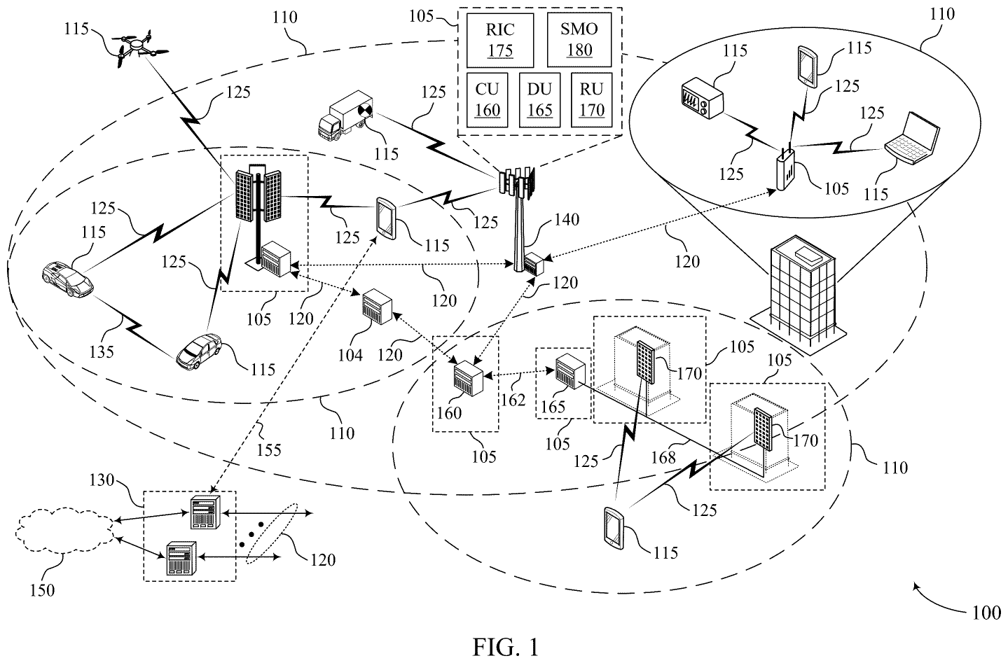

FIG. 1 shows an example of a wireless communications system 100 that supports scalability parameters for PDU set traffic in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., RLC layer, MAC layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a personal computer, a netbook, a smartbook, a personal computer, a smart device, a wearable device (e.g., a smart watch, smart clothing, smart glasses, virtual reality (VR) goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some cases, a UE 115 may communicate with a network entity 105 via MAC-CE. The UE 115 may transmit a delay status report (DSR) MAC-CE to the network entity 105-a. The DSR MAC-CE may indicate a remaining delay budget of a PDU. The remaining delay budget of a PDU may be the remaining time of a PDCP discard timer associated with the PDU, and may correspond to a remaining amount of time available in which to successfully communicate the PDU to a receiver. The UE 115 may include an indication of logical channel groups (LCG) that have triggered DSR in the DSR MAC-CE. For example, a DSR MAC-CE may include a bitmap that indicates which LCGs are reporting their delay status. Additionally, or alternatively, for each LCG, the MAC-CE may indicate the amount of data associated with a remaining time that is below one or more reporting thresholds. The bitmap may indicate which BSR table is used to report the amount of data below each configured reporting threshold.

According to techniques described herein, the UE 115 may receive an indication of a PDU set configuration for a PDU set. The PDU set configuration may include one or more parameters (e.g., latency parameters) and a scalability parameter associated with the one or more parameters. The UE 115 may monitor a set of one or more scaling trigger conditions associated with the application of the scalability parameter. The UE 115 may apply the scalability parameter to one or more parameters based on a scaling trigger condition of the set of scaling trigger conditions satisfying a threshold. For example, the UE 115 may apply a scalability parameter to the one or more parameters based on a congestion state indication through downlink MAC-CE. The scalability parameter may increase or decrease a parameter by a given percentage. The UE 115 may transmit a control message based on a parameter satisfying a threshold in accordance with the scalability parameter. The scalability parameter may decrease latency and improve efficient use of communication resources by providing dynamic adaptation of network configured parameters.

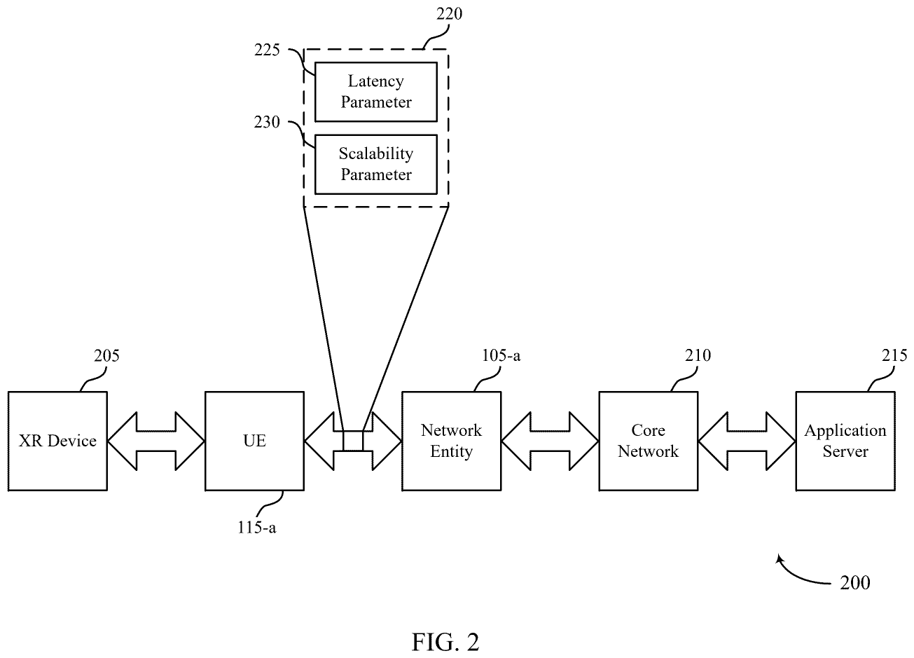

FIG. 2 shows an example of a wireless communications system 200 that supports scalability parameters for PDU set traffic in accordance with one or more aspects of the present disclosure. In some examples, wireless communications system 200 may implement aspects of wireless communications system 100. For example, a UE 115-a may represent an example of a UE, such as the UEs 115 described with reference to FIG. 1. A network entity 105-a may represent an example of a network entity, such as the network entities 105 described with reference to FIG. 1. An extended reality (XR) device 205 may represent an example of a UE, such as the UE 115 described with reference to FIG. 1, an augmented reality (AR) device, a VR device, a mixed reality (MR) device, user head mounted display (HMD), or another wireless device. The network entity 105-a and the UE 115-a may communicate via one or more communication links. The network entity 105-a may transmit a control message 220 including parameter 225 (e.g., a latency parameter) and a scalability parameter 230 to the UE 115-a.

In some wireless communications systems, a UE 115-a may run an XR application and communicate data to the XR device 205 based on the XR application. An application data unit (ADU) may be a smallest (e.g., minimum) unit from the XR application sent between the application server 215 (e.g., network) and XR device 205 (e.g., user HMD). The ADU may include one or more PDUs or packets. For example, the ADU may include a frame such as a video frame or an audio frame associated with the XR application. The frame may utilize different coding mechanisms based on an underlying protocol and frame refresh rate. For example, different coding mechanisms may be associated with different coding characteristics based on a resolution associated with the frame.

XR traffic (e.g., VR traffic, AR traffic, or MR traffic) may be very time sensitive and packet loss sensitive from a user experience perspective. The XR traffic may be associated with one or more parameters 225 to ensure the successful delivery of an ADU within the stipulated time limits to meet a jitter metric. For example, the ADU may be associated with a parameter 225 that indicates a time limit (e.g., timer) for successful delivery of the ADU based on the jitter metrics associated with the XR traffic.

The parameters 225 may be indicated in a configuration message, such as indicating an RLC polling configuration (e.g., RLC triggers or timers), a MAC BSR configuration (e.g., BSR timer), or PHY layer triggers or timers. For RLC polling, the UE 115-a may be configured with a duration of an RLC polling timer that is associated with a PDU set. When the polling timer expires or a polling trigger is satisfied, the UE 115-a may transmit an RLC polling message requesting the receiver (e.g., the network entity 105-a) to acknowledge a set one or more previously transmitted PDUs stored in a retransmission buffer at the UE 115-a. The UE 115-a may retransmit or remove from the buffer one or more PDUs of the set of PDU based on the response. For example, if the response indicates the negative acknowledgment (NACK) or the UE 115-a does not receive a response in a given duration, the UE 115-a may retransmit one or more previously transmitted PDUs of the set of PDUs from the retransmission buffer. If the UE 115-a receives an acknowledgment, the UE may discard the one or more previously transmitted PDUs of the set of PDUs, or the entire PDU set, from the retransmission buffer.

A smaller duration or delay associated with the RLC polling timer or a smaller RLC polling trigger may enable the UE 115-a to retransmit earlier unreceived PDUs. For example, if the RLC polling timer is set for 128 ms and a PDU transmitted 20 ms after the start of the RLC polling timer is lost or discarded, the UE 115-a may retransmit the lost PDU after the 128 ms timer expires increasing the PDU set latency. If the RLC polling timer is set for 32 ms and the PDU transmitted 20 ms after the start of the RLC polling timer is lost or discarded, the UE 115-a may retransmit the lost PDU after 32 ms. The smaller duration or delay associated with the 32 ms timer may decrease PDU set latency.

For RLC status, a receiving device (e.g., a UE 115-a or a network entity 105-a) may not receive one or more PDUs from a transmitting device (e.g., a UE 115-a or a network entity 105-a). The receiving device may receive a poll request indicating for the receiving device to transmit a status response (e.g., a ACK or NACK). The receiving device may delay transmitting a status request based on an RLC reassembly timer. After the RLC reassembly timer expires, the receiving device may transmit a status request. In some cases, the receiving device may be gated (e.g., limited) from transmitting a status request based on a RLC status prohibit timer. The RLC reassembly timer and the RLC status prohibit timer may increase delay associated with retransmission of a discarded or lost PDU. For example, the RLC reassembly timer and the RLC status prohibit timer may delay receiving a PDU set (e.g., receiving a PDU set at the network entity 105-a). The RLC reassembly timer and the RLC status prohibit timer may increase a PDU set delay based on delaying retransmission of a missing or discarded PDU.

For MAC BSR, the UE 115-a may monitor the quantity of data in a transmission buffer to determine when to transmit a BSR. For example, when a transmission buffer at the UE 115-a exceeds a buffer threshold, the UE 115-a may transmit a BSR to request a grant for transmission of data from the transmission buffer. The buffer threshold may gate (e.g., limit) when the UE 115-a may transmit a BSR. A smaller buffer threshold may enable to the UE 115-a to request a grant earlier, decreasing the delay associated with transmitting a PDU. Additionally, or alternatively, a BSR retransmission timer may gate (e.g., limit) when the UE 115-a may transmit a BSR retransmission. For example, if the UE 115-a transmits a BSR and does not receive a response, the UE 115-a may delay transmitting a BSR retransmission until the expiration of the BSR timer. A smaller duration or delay associated with the BSR timer may enable the UE 115-a to transmit a BSR retransmission earlier. For example, if the UE 115-a does not receive a grant in response to a BSR, the UE 115-a may transmit a BSR retransmission earlier for BSR retransmission timer associated with a smaller duration or delay. The earlier BSR retransmission may decrease PDU set latency.

The ADU may include FEC information to correct one or more missing bits. That is, the FEC may add a level of redundancy using various sub-techniques (e.g., Flex FEC, maximum distance separable (MDS), raptor code based). For example, a receiving device (e.g., a UE 115-a or an application server 215) may reconstruct a lost packet of an ADU based on the FEC information. A transmitting entity may be capable to inspect and understand the relation between packets in terms of systematic or redundancy packets. The ratio of systematic bit to redundancy bits may be based on the sub-technique used. For example, an ADU may include ten systematic packets and five redundancy packets. The receiving device may be capable of reconstructing the ten systematic packets based on receiving any set of at least ten packets included in the ADU. For example, two systematic packets may be delayed or discarded. The receiving device may reconstruct the two systematic packets based on receiving at least two redundancy packets.

The ADU may be transmitted via radio protocol and IP domain protocol. For example, an application server 215 may generate an ADU at a datum server. The application server 215 may output the ADU to the UE 115-a via a transmission control protocol (TCP) connection. The application server 215 may output the ADU to the core network 210 via a backhaul communication link. In some cases, the core network 210 may obtain the ADU via one or more routers. The core network 210 may be an example or a proxy, gateway, or user plane function (UPF). The core network 210 may output the ADU to a network entity 105 via an evolved packet core (EPC) (e.g., an S1 user (S1U) interface) or a next generation user plane interface (NG-U) for next generation (NG) core. In some cases, the network entity 105-a may include a CU and one or more DUs as described with reference to FIG. 1. The CU of the network entity 105-a may obtain the ADU via a PDCP uplink layer. The CU of the network entity 105-a may output the ADU to a DU of the network entity 105-a via new radio unlicensed (NR-U). The DU of the network entity 105-a may process the ADU through one or more radio protocols (e.g., RLC, MAC, or layer one). The network entity 105-a may output the ADU to the UE 115-a via a radio communication link. The UE 115-a may process the ADU through one or more radio protocols (e.g., PDCP, RLC, MAC, or layer one). The UE 115-a may receive the ADU via the TCP connection via an IP accelerator software layer, an IP accelerator hardware layer, and a TCP or a high level operating system (HLOS) layer. The UE 115-a may receive the ADU in the IP domain via radio protocols. The application server 215, core network 210, network entity 105-a, or UE 115-a may perform data buffering of one or more packets of the ADU. For example, various buffering entities (e.g., the application server 215, the core network 210, the network entity 105-a, or the UE 115-a) across the cellular network may buffer one or more packets of the ADU, and the latency impact of the packet buffering may build up. The radio protocols may generate latency impacting the overall application round trip time, packet loss, block error rate (BLER) at HARQ, or RLC ARQ level.

While the ADU is transmitted over the radio network (e.g., 5G NR), the ADU may go through various radio protocols to ensure successful delivery. The protocols may include packetization at the PDCP, segmentation at the RLC, retransmission at the RLC layer, and redundancy at the HARQ based physical layer transmission. For example, the UE 115-a may attempt a HARQ recovery based on the redundancy of the physical layer transmission. If the HARQ recovery is unsuccessful, the UE 115-a may receive a retransmission at the RLC layer.

One ADU packet may be divided into N PDCP packets and transmitted via a wireless communication link (e.g., over the air). The N PDCP packets may be referred to as a PDU Set. For example, the PDU set may be a group of PDUs representing one ADU packet. The PDU set may include quality of service (QOS) metrics such as PDU set delay budget (PSDB), PDU set error rate (PSER), PDU session importance (PSI), and PDU set Integrated Handling Indication (PSIHI). A largest (e.g., maximum value of) PDCP packet size may be fixed in the radio interface based on the maximum transport unit (MTU) settings exchanged over cellular signaling messages (e.g., PDU session) between the network entity 105-a and the UE 115-a.

For example, the ADU may be a video frame of 300 kilobytes (kB). The largest PDCP packet size may be 1.5 kB based on the MTU size configured in the PDU sessions establishment. The ADU of 300 kB may be divided into 200 IP packets which may be converted into 200 PDCP PDU packets. The 200 PDU packets may be a PDU set associated with a set of PDU set metrics (e.g., PSDB, PSER, PSI, PSIHI).

The PDU set may utilize one or more PDU set features at various radio protocol layers. At the MAC layer, a DSR may indicate a delay sensitive buffer value. A BSR may indicate if a PDU set is complete or not complete. The MAC layer may implement measurement gap relaxation for the PDU set. At the PDCP layer, the network entity 105-a may transmit a congestion indication regarding resource or grant issues. The PDCP layer may discard PDUs based on the PSI associated with the PDU. For example, the PDCP layer may discard PDUs associated with a low priority and keep (e.g., protect) PDUs associated with a higher priority. The UE 115-a may transmit a PSIHI when all PDUs in PDU set are not received. For example, the PSIHI may indicate a quantity of packets that are utilized to reconstruct the systematic packets. A transmitting device (e.g., the UE 115-a or the network entity 105-a) may transmit a PDCP Control PDU to inform window movement. For example, the PDCP control PDU may indicate the discarding of one or more PDU packets. The receiving device (e.g., the UE 115-a or the network entity 105-a) may proceed to a next window based on the indication of the discarded PDU packets. That is, the receiving device may not wait for the discarded packet prior to proceeding to the next window.

Additional RLC configuration parameters (e.g., parameters 225) may impact the PDU Set latency constraints (e.g., latency requirements). The parameters 225 may be configured for all PDU traffic. The parameters may not be configured based on the dynamic PDU set metrics or network conditions. For example, an RLC polling configuration may impact how often a transmitting device (e.g., transmit entity) requests status by setting a polling bit in a PDU of the ADU. The RLC polling configuration may indicate a frequency or data volume threshold for when the polling bit is to be transmitted (e.g., PollPDU or PollBytes). The RLC polling configuration may be constant for all PDU traffic. That is, the RLC polling configuration may be constant regardless of a PSI associated with the PDU set or network conditions. When a PDU set is transmitted, the RLC polling configuration may not provide status information in accordance with the jitter metrics associated with the PDU set. For example, an RLC polling configuration may be configured to transmit a polling bit 128 ms after transmitting a previous polling bit. To provide status information in accordance with the jitter metrics, however, the transmitting device may rely on an RLC polling configuration of 32 ms to meet jitter metrics. The slow RLC polling configuration may increase latency at the transmitting device.

When a status is not received in response to a polling bit, a polling timer may be used by the transmitting side of an acknowledgment mode (AM) RLC entity in order to retransmit a poll (e.g., a polling bit). The polling timer may be set based on the RLC polling configuration (e.g., t-PollRetransmit). The polling timer may not be based on PDU set metric or channel conditions increasing latency associated with the PDU set.

The receiving device may declare the packet as missing and request through Status initiation based on an expiration of a reassembly timer (e.g., T-reassembly). That is, declaring the packet as missing and requesting reassembly through status initiation from the receiving device may be gated by T-reassembly expiry. For example, a transmitter side may transmit four packets (e.g., packets 0, 1, 2, and 3). The receiving device may receive some of the four packets (e.g., packets 1, 2, and 3). The receiving device may wait until the expiration of a reassembly timer (e.g., T-reassembly) to declare the missing packet (e.g., packet 0) as missing and to request the status of the missing packet. A status prohibit timer may gates the transmission of a status PDU. For example, the receiver side may not transmit a status PDU based on a status prohibit timer (e.g., t-StatusProhibit) running.

Additional MAC configuration parameters (e.g., parameters 225) may impact the PDU Set latency constraints (e.g., latency requirements). The parameters 225 may be configured for all PDU traffic. The parameters may not be configured based on the dynamic PDU set metrics or network conditions. For example, BSR retransmission may be gated by a BSR retransmission timer (e.g., retxBSR-Timer). The BSR retransmission timer may address a case where grant for transmission is not coming). For example, the UE 115-a may transmit a BSR to the network entity 105-a. If the UE 115-a does not receive a grant from the network entity 105-a, the UE 115-a may wait unit the expiration of the BSR retransmission timer. The UE 115-a may retransmit the BSR to the network entity 105-a based on an expiration of the BSR retransmission timer. The UE 115-a may discard one or more packets while waiting for the expiration of the BSR retransmission time decrease user experience. Additionally, or alternatively, a periodic BSR timer (e.g., periodicBSR-Timer) may be used to send BSR periodically even when data is present. For example, the periodic BSR timer may indicate a periodicity for BSR transmission. The periodicity for BSR transmission may be constant for all PDU transmission and may not be based on PDU set metrics or network conditions. The RLC and MAC configuration parameters may increase PDU set latency based on blocking or gating retransmissions or status information.

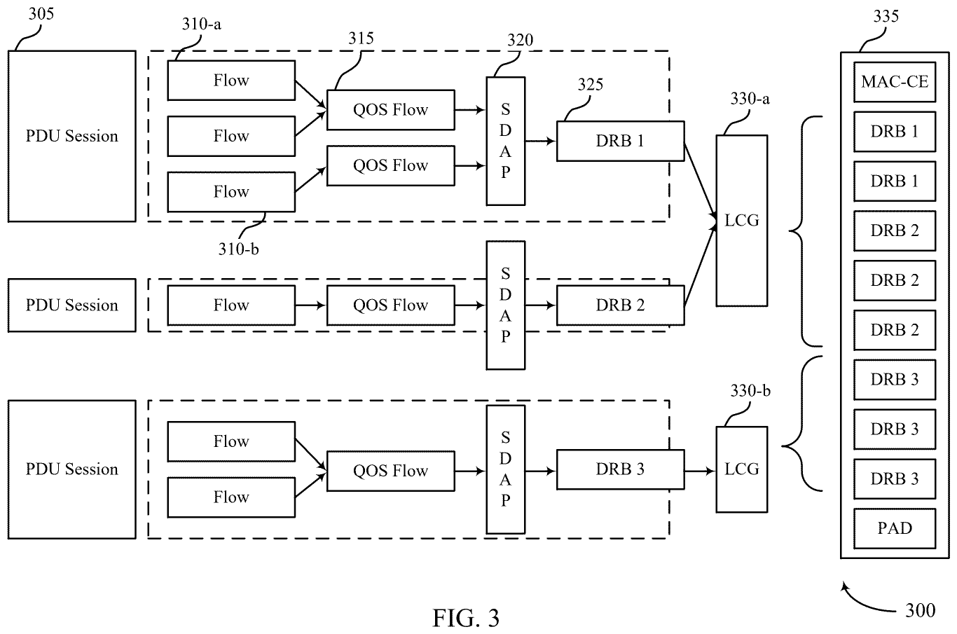

The network entity 105-a may provide a dynamic grant (DG) or configured grant (CG) to address the PDU Set related QOS constraint (e.g., QOS requirements) (PSDB, PSER) based on DSR reported to drain the priority traffic. In some cases, multiple flows (e.g., multiple flows as described with reference to FIG. 3) may be mapped on to a bearer. Some flows may be PDU Set specific and other may be PDU specific. Flows associated with PDU set traffic and PDU traffic being associated with the same configuration for RLC and MAC may increase latency based on the shared configuration parameters as described with reference to FIG. 3. For example, there may be no variation in the behavior of the RLC timers or triggers (e.g., polling triggers or polling timers and status triggers and status timers) and MAC BSR related timers between different traffic (e.g., PDU set flow and normal flow). Additionally, or alternatively, retransmissions conditions at RLC level or grant pattern may not be sufficient at MAC. Without considering RLC timers or triggers (e.g., polling triggers or polling timers and status triggers and status timers) and MAC BSR timers during PDU Set related traffic presence, PSI high data, or during congestion state, retransmissions and grant pattern may not scale to address the PDU Set key performance indicator (KPI) constraints (e.g., KPI requirements).

In a steady state mode, it may be beneficial to speed up the status or polling parameters 225 (e.g., RLC polling or status triggers and BSR retransmission timer) to meet PDU set KPI. In a congestion mode, packets associated with a PDU set including a low priority PSI (e.g., a PSI of zero) may be discarded and packets associated with a PDU set including a high priority PSI (E.g., a PSI of one) may be kept (e.g., protected). It may be beneficial to modify the status or polling parameters 225 (e.g., RLC polling or status triggers and BSR retransmission timer) based on the congestion mode and the PDU set KPI.

In some cases, when a HARQ fails, other associated RLC packets may be lost. For example, the other RLC packets may be successfully carrying other packets (e.g., the HARQs associated with the other RLC packets may pass). The UE 115-a may buffer the other RLC packets at receive window while the reassembly timer runs. For example, for T-reassembly amount of time, other packets may be buffered at the receive window. After the reassembly timer expirers (e.g., T-reassembly expiry), the UE 115-a (e.g., the RLC AM receive entity) may initiate the status PDU. The status PDU may be further delayed by the status prohibit timer (e.g., if the status prohibit timer is running to request for retransmission from a transmitter).

In some cases, when specific BSR is triggered but no uplink grant is received, retransmission BSR condition may be gated by BSR retransmission timer value. For example, to initiate a next BSR to request the network entity 105-a for a grant or to update latest BSR, the UE 115-a may delay BSR retransmission based on the BSR retransmission timer. The delay from the BSR retransmission timer may increase PDU set latency. In some cases, due to insufficient grant, loading conditions, or PHR limitations a PDU set may run into a discard mode of operation. During PSDB timer expiry, the UE 115-a may drop the packets associated to the PDU set. If DSR is configured, DSR will be sent out based on the uplink grant availability. In some cases, due to congestion identified by network entity 105-a and indicated to the UE 115-a via downlink MAC-CE, the UE 115-a may discard the low priority (e.g., PSI low) PDU sets. The UE 115-a may transmit high priority (e.g., PSI high) PDU sets. The delay from the triggers or timers may increase the PDU set latency.

In some cases, loading and grant pattern may be very dynamic with a high burstiness of the traffic and radio conditions (e.g., commercial deployments). The delay from the triggers or timers may be increased further based on the dynamic traffic. The UE 115-a behavior may not differ from RLC Polling and Status triggers or timers and MAC BSR timers or triggers, to improve performance.

According to techniques described herein, one or more parameters (e.g., RLC polling or status; MAC BSR configuration triggers, timers, and counters; or PHY layer triggers, timers, and counters) may be scaled by a scalability parameter 230 based on one or more scaling trigger conditions. For example, RLC polling or status and MAC BSR configuration (e.g., parameters such as triggers, timers, counters) may be scalable based on PDU set metrics, dynamic information about retransmission, and network congestion state. The UE 115-a may apply a scalability parameter 230 (e.g., a scalability parameter of 50%) to a timer based on a scaling trigger condition. The application of the scalability parameter may reduce the delay associated with the timer by the scalability parameter 230 (e.g., for a scalability parameter of 50%, a duration associated with the timer may be reduced by 50%).

The network entity 105-a may transmit a control message 220 including a scalability parameter 230 to the UE 115-a. The scalability parameter 230 (e.g., one or more scalability values) may be applied to RLC and MAC timers or triggers (e.g., one or more parameters 225). The scalability parameter 230 may be applied to parameters 225 individually or collectively. For example, the scalability parameter 230 may be applied to all parameters 225 or the scalability parameter 230 may be applied to a subset of parameters 225. The scalability parameter 230 may be configured via a semi-static radio resource control (RRC) configuration or dynamically through a MAC-CE indication.

The scalability parameter 230 may be applied to one or more parameters based on one or more scaling trigger conditions (e.g., triggering conditions). A scaling trigger condition may be based on a congestion state indicated via downlink MAC-CE. For example, the UE 115-a may apply the scalability parameter 230 to one or more parameters 225 based on receiving an indication of a network congestion state. A scaling trigger condition may be based on a PDU set KPI metric (e.g., PDU set discard KPI metric) at the UE 115-a. The PDU set KPI metric may be an example of one or more of a PSDB, a PSER, a PSI, a PSIHI, or any combination thereof. For example, the UE 115-a may apply a first scalability parameter 230 to one or more parameters 225 based on a PDU set discard percentage exceeding a first threshold (e.g., 5%). The UE 115-a may apply a second scalability parameter 230 to one or more parameters 225 based on a PDU set discard percentage exceeding a second threshold (e.g., 10%).

A scaling trigger condition may be based on a remaining transmission time associated with a PDU set. That is, a scaling trigger condition may be based on DSR triggering event. For example, the UE 115-a may indicate an expected (e.g., critical) timeline for the traffic or PDU set (e.g., for DSR triggered due to 50 ms remaining delay budget criteria). Additionally, or alternatively, a scaling trigger condition may be based on a remaining volume of traffic associated with a PDU set (e.g., a buffer status). For example, the scaling trigger condition may be based on a DSR triggering event where the UE 115-a indicates an expected (e.g., critical) timeline for the volume of traffic (e.g., more than 200 KB meeting a DSR trigger). A scaling trigger condition may be based on a HARQ BLER detected at (e.g., known to) the UE 115-a (e.g., first BLER or residual BLER). For example, if the BLER detected at the UE 115-a exceeds a threshold the UE 115-a may decrease the delay of the polling timer to facilitate faster polling between the UE 115-a and the network entity 105-a. A scaling trigger condition may be based on the grant pattern and actual data rate exceeding a threshold. For example, the UE 115-a may apply the scalability parameter 230 to one or more parameter 225 based on a ratio between the grant pattern and the actual data rate exceeding a threshold (e.g., the grant pattern may be less than 50% of the actual data traffic).

For example, the scalability parameter 230 may be 50%. When any of the scaling trigger condition is met, associated parameters 225 (e.g., RLC timers, RLC polling or status triggers or counters and MAC BSR related timers) may be scaled by 50%. For example, the RLC polling configuration may include a data volume threshold of 500 KB (e.g., pollByte may be 500 KB). When the scalability parameter 230 is applied to the RLC polling configuration, the data threshold may be reduced from 500 kB to 250 kB (e.g., instead of transmitting a poll bit after 500 kB, a poll bit may be transmitted after 250 kB). In some examples, the scalability parameter 230 may be applied to the BSR retransmission timer. The BSR retransmission timer may include a delay of 160 ms (e.g., retxBSR-timer may be 160 ms). When the scalability parameter 230 is applied to the BSR retransmission timer, the delay may be reduced from 160 ms to 80 ms. The updated delay associated with the BSR retransmission time timer may be used to quickly send BSR to network entity 105-a for a grant.

For RLC polling, if one or more scaling trigger conditions is satisfied (e.g., the UE 115-a receives an indication of network congestion, the UE 115-a detects or is notified of high BLER, or the like), the UE 115-a may apply the scalability parameter 230 to the parameter 225 (e.g., the duration of a RLC polling timer may be scaled by the scalability parameter 230). In other words, when the scaling trigger condition is satisfied, then the UE 115-a may apply the scaling percentage to the RLC polling duration or RLC polling trigger. In some cases, the reduced timer duration may enable the UE 115-a to increase the frequency of RLC polling message to the receiver. The increased frequency of RLC polling message to the receiver may increase the likelihood the UE 115-a retransmits an PDU earlier. By decreasing the delay associated with PDU retransmission, the UE 115-a may decrease an overall TCP connection delay making the PDU set more likely to be successfully received in accordance with the jitter metrics.

For example, the UE 115-a may be configured with a RLC polling trigger of 100 KB (e.g., parameter 225) and a scaling factor of 50% (e.g., scalability parameter 230) via the control message 220. The UE 115-a may transmit a RLC polling message after transmitting 100 KB of data. The UE 115-a may store the previous 100 kB of data in an RLC retransmission buffer for possible retransmission. The UE 115-a may apply the scaling factor of 50% to the RLC polling trigger of 100 kB based on a scaling trigger condition. For example, the UE 115-a may scale the RLC polling trigger of 100 kB to 50 kB for the PDU set based on a HARQ BLER detected at the UE 115-a. The UE 115-a may transmit a PDU after transmitting 30 kB. The PDU may be lost or discard before being received by the receiving device. The UE 115-a may transmit a RLC polling message after transmitting 50 kB based on the scaling trigger condition and scalability parameter 230. The UE 115-a may receive a NACK based on the PDU being lost or discard. The UE 115-a may retransmit the lost or discarded PDU, which may be stored in the RLC retransmission buffer, based on receiving a NACK. The scalability parameter may decrease the latency associated with the retransmission of the lost or discarded PDU based on reducing the RLC polling trigger.

For RLC status, if one or more scaling trigger conditions is satisfied, a receiving device (e.g., a UE 115-a or a network entity 105-a) may apply the scalability parameter 230 to one or more parameter 225 (e.g., the duration of a RLC reassembly timer or a RLC status prohibit timer may be scaled by the scalability parameter 230). In other words, when the scaling trigger condition is satisfied, then the receiving device may apply the scaling percentage to the RLC reassembly timer or RLC status prohibit timer. In some cases, the reduced timer duration may enable the receiving device to provide a status request faster decreasing the delay associated with retransmission of a discarded or missing PDU. For example, a receiving device may provide faster feedback to the transmitting device enabling the transmitting device to retransmit a discarded or missing PDU with less delay. By decreasing the delay associated with PDU retransmission, the receiving device may decrease an overall TCP connection delay making the PDU set more likely to be successfully received in accordance with the jitter metrics.

For example, the receiving device may be configured with an RLC reassembly timer of 50 ms (e.g., parameter 225), a status prohibit timer of 250 ms (e.g., parameter 225), and a scaling factor of 50% (e.g., scalability parameter 230) via the control message 220. The receiving device may receive a poll request. The receiving device may delay transmitting a status response until an expiration of a reassembly timer (e.g., 50 ms). Additionally, or alternatively, the receiving device may delay transmitting a status response until the expiration of a status prohibit timer. For example, the receiving device may delay transmitting a status response 200 ms after the start of the status prohibit time for 50 ms. The receiving device may apply the scaling factor of 50% to the RLC status reassembly timer based on a scaling trigger condition. For example, the receiving device may scale the reassembly timer by 50% from 50 ms to 25 ms and respectively and the status prohibit timer from 250 ms to 125 ms. The receiving device may transmit a status response (e.g., an ACK or NACK) after 25 ms. Additionally, or alternatively, the receiving device may transmit a status response 200 ms after the start of the status prohibit timer without delay. The scalability parameter may decrease the latency associated with the retransmission of one or more lost or discarded PDUs and status reporting based on reducing the RLC reassembly timer or the status prohibit timer.

For MAC BSR, if one or more scaling trigger conditions are satisfied, the UE 115-a may apply the scalability parameter 230 to the parameter 225 (e.g., the threshold amount of buffered data before the UE 115-a may transmit a BSR or the duration of the BSR retransmission timer). In other words, when a scaling trigger condition is satisfied, the UE 115-a may apply the scaling percentage to the buffer threshold or retransmission timer. The UE 115-a may transmit the BSR to the receiving device based on the quantity of data in the buffer exceeding the scaled buffer threshold. Additionally, or alternatively, the UE 115-a may retransmit the BSR to the receiving device based on the scaled BSR retransmission timer expiring. The decreased delay based on the scaled buffer threshold and scaled BSR retransmission timer may increase the quantity and timeliness of BSR transmissions, which may enable the UE 115-a to transmit a PDU earlier based on receiving a grant to transmit the PDU earlier. By decreasing the delay associated with PDU transmission, the UE 115-a may decrease an overall TCP connection delay making the PDU set more likely to be successfully received in accordance with the jitter metrics.

For example, the UE 115-a may be configured with a BSR retransmission timer of 20 subframes (e.g., parameter 225) and a scaling factor of 25% (e.g., scalability parameter 230) via the control message 220. The UE 115-a may transmit a BSR based on a quantity of data in a transmission buffer at the UE 115-a exceeding a threshold. The UE 115-a may not receive a response to the BSR, and the UE 115-a may wait until the expiration of the BSR retransmission timer to transmit a BSR retransmission. The UE 115-a may apply the scaling factor of 25% to the BSR retransmission timer based on a scaling trigger condition. For example, the UE 115-a may scale the BSR retransmission timer of 20 subframes to 5 subframes based on receiving an indication from the network entity 105-a indicating a network congestion state. The UE 115-a may transmit a BSR after exceeding the buffer threshold. The UE 115-a may not receive a grant in response to the BSR. The UE 115-a may transmit a BSR retransmission after 5 subframes based on the scaling trigger condition and scalability parameter 230. The UE 115-a may receive a grant in response to the BSR retransmission. The scalability parameter may decrease the latency associated with the transmission of a PDU based on reducing the BSR retransmission timer and decreasing the delay associated with receiving a grant at the UE 115-a.

In some examples, a first PDU set may be associated with a first PSDB including a first acceptable PDU set delay of 100 ms. The first acceptable PDU set delay of 100 ms may not satisfy a scalability trigger condition (e.g., the first acceptable PDU set delay may not satisfy a latency threshold for applying the scalability parameter 230), and the scalability parameter 230 may not be applied to the parameters 225. In some examples, a second PDU set may be associated with a second PSDB including an acceptable PDU set delay of 40 ms. The second acceptable PDU delay of 40 ms may satisfy the scalability trigger condition, and the scalability parameter 230 may be applied to one or more parameters 225 to reduce the latency associated with the parameters 225.

The scalability parameter 230 may be a single value or multiple values (e.g., the scalable parameter may be 75%, 50%, or 25%), which may be tied to different scaling trigger conditions (e.g., conditions or different thresholds in the conditions) respectively. The UE 115-a may apply the scalability parameter 230 to help fast recovery of the packets and to help the quick transmission of the packets. The scalability parameter 230 may be specific to each parameter 225 (e.g., timer, counter, trigger) or common to all the parameters 225 (e.g., configuration at each module level). In some cases, the scalability parameter 230 may be applied to the polling timer. In some cases, the scalability parameter 230 may be applied to the polling timer and the RLC polling configuration. For example, the scaling parameter 230 may include a poll specific scalable factor, a status specific scalable factor, or a same scalable factor for all RLC configuration.

In some examples, when the UE 115-a transmits the DSR, the UE 115-a may assume the associated timers are adapted with the associated scaling. For example, an RRC configuration may include a mapping between the DSR thresholds and an associated scaling factor. When the UE 115-a triggers the report, both the network entity 105-a and the UE 115-a may be aware of scalability of the parameters. The scalability parameter 230 (e.g., new parameters) may persistent until a new RRC reconfiguration or until a new DSR reporting with different values and mapping.

Although initially described in the context of RLC polling, RLC status, and MAC BSR, it should be understood that additional timers or triggering conditions for existing protocols may be scaled (e.g., based on the scalability parameter) at the RLC layer or the MAC layer based on PDU Set characteristics.

In some cases, the UE 115-a may determine a scalability parameter 230 in accordance with the control message 220. The network entity 105-a may evaluate channel conditions (e.g., radio conditions), and the network entity 105-a may determine the scalability parameter 230. For example, the network entity 105-a may determine the scalability parameter 230 using a machine learning (ML) model at the network entity 105-a. The control message 220 may indicate the scalability parameter 230, and the UE 115-a may apply the scalability parameter 230. In some cases, the UE 115-a may determine the scalability parameter 230 independently using a ML model at the UE 115-a. For example, the UE 115-a may evaluate one or more channel conditions or an operating state of the UE 115-a, or both, for determining the scalability parameter 230. The UE 115-a may evaluate the one or more channel conditions in accordance with one or more channel measurements, one or more communication metrics, or both. In some cases, the UE 115-a may determine the scalability parameter 230 in accordance with the control message 220 and the ML model at the UE 115-a. For example, the control message 220 may indicate a first scalability parameter 230 (e.g., 50%). The UE 115-a may determine a second scalability parameter 230 (e.g., 47%) by inputting one or more of the first scalability parameter 230, the channel conditions, or an operating state of the UE 115-a into the ML model. The second scalability parameter 230 may be based on an output of the ML model.

FIG. 3 shows an example of a PDU session flow 300 that supports scalability parameters for PDU set traffic in accordance with one or more aspects of the present disclosure. In some examples, PDU session flow 300 may implement aspects of wireless communications system 100 and wireless communications system 200. For example, the PDU session flow 300 may be implemented by a UE 115 as described with reference to FIGS. 1 and 2.

The PDU traffic at the UE 115 may include one or more PDU sessions 305. A PDU session 305 may include one or more flows 310 (e.g., app flows). The flows 310 may be an example of a PDU set traffic or PDU traffic. For example, flow 310-a may be an example of PDU set traffic and flow 310-b may be an example of PDU traffic. The flow 310-a may be associated with a first QOS flow 315, and the flow 310-b may be associated with a second QOS flow 315. Both the flow 310-a and the flow 310-b may be associated with the same service data adaptation protocol (SDAP) 320. Both the flow 310-a and the flow 310-b may be associated with the same data radio bearer (DRB). The flow 310-a and the flow 310-b may be associated with the same parameters (e.g., RLC polling or status and MAC BSR configuration triggers, timers, and counters) based on the flow 310-a and the flow 310-b being associated with the same DRB. For example, the flow 310-a may be associated with parameters (e.g., latency parameters) configured for the PDU session 305. The parameters may not be dynamic or associated with the PDU set metrics of the flow 310-a. The PDU session 305 may be associated with an LCG 330-a. The LCG 330-a and a LCG 330-b may correspond to a respective LCG priority. The UE 115 may encode data from one or more DRB 325 in an encoded MAC transport block (TB) 335. The data included in the encoded MAC TB 335 may be based on the LCG priority and LCG rules. The UE 115 may transmit the encoded MAC TB 335 to the network entity 105-a.

According to techniques described herein, the UE 115 may receive an indication of a PDU set configuration for a PDU set. The PDU set configuration may include parameters (e.g., RLC polling or status and MAC BSR configuration triggers, timers, and counters) and a scalability parameter associated with the parameters. The UE 115 may monitor a set of scaling trigger conditions associated with the application of the scalability parameter. The UE 115 may apply the scalability parameter to one or more parameters based on a scaling trigger condition of the set of scaling trigger conditions satisfying a threshold. For example, the UE 115 may apply the scalability parameter to the flow 310-a. The scalability parameter may alter the parameters associated with the flow 310-a, but the parameters may remain constant for the flow 310-b (e.g., the non-PDU set flow). The scalability parameter may enable dynamic updates to the parameters based on the PDU metrics of the flow 310-a or the network conditions.

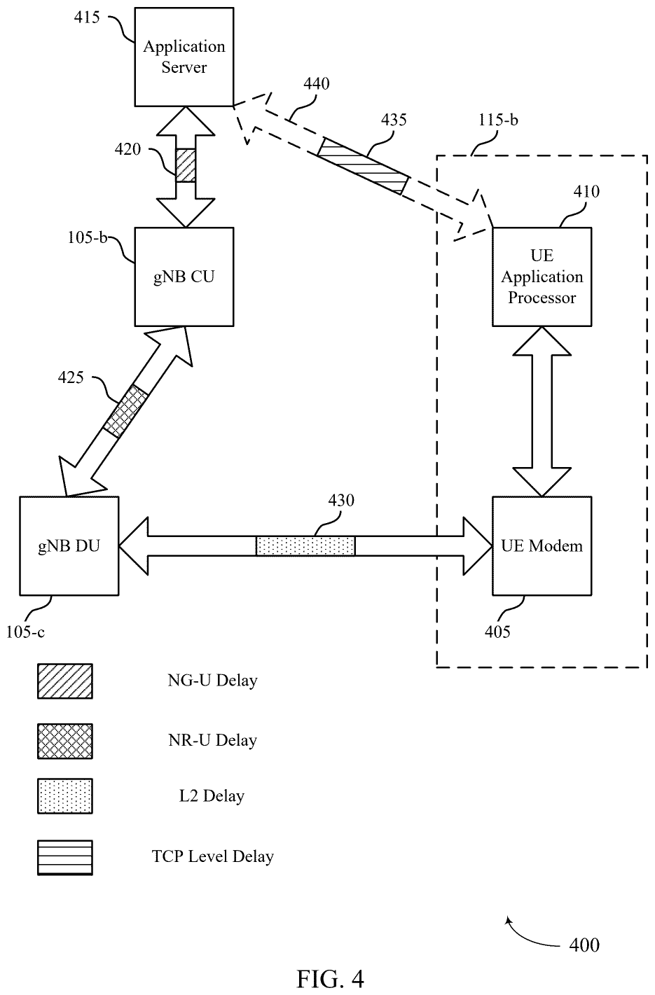

FIG. 4 shows an example of a wireless communications system 400 that supports scalability parameters for PDU set traffic in accordance with one or more aspects of the present disclosure. In some examples, the wireless communications system 400 may implement aspects of, or be implemented by aspects of, the wireless communications system 100, the wireless communications system 200, or the PDU session flow 300. For example, a UE 115-b, a network entity 105-b (e.g., gNB CU), a network entity 105-c (e.g., gNB DU), or an application server 415 may be examples of corresponding devices described with reference to FIGS. 1-3. The UE 115-b may include a UE modem 405 and a UE application processor 410.

The UE 115-b may communicate with the application server 415 via a TCP connection 440. The TCP connection 440 may be associated with a TCP level delay 435. The TCP level delay 435 may be based on a layer 2 delay 430, an Xn delay, and a buffering delay (e.g., a buffering delay at the application server and the UE modem 405. The Xn delay may be based on a NG-U delay 420 and a NR-U delay 425.

According to techniques described herein, the UE 115-b may receive an indication of a PDU set configuration for a PDU set. The PDU set configuration may include parameters (e.g., RLC polling or status and MAC BSR configuration triggers, timers, and counters) and a scalability parameter associated with the parameters (e.g., latency parameters). The UE 115-b may monitor a set of scaling trigger conditions associated with the application of the scalability parameter. The UE 115-b may apply the scalability parameter to one or more parameters based on a scaling trigger condition of the set of scaling trigger conditions satisfying a threshold. A scaling trigger condition may be based on the TCP level delay 435. In some cases, the UE 115-b may reduce the buffering delay associated with the PDU set based on the scalability parameter, as described with reference to FIG. 2.

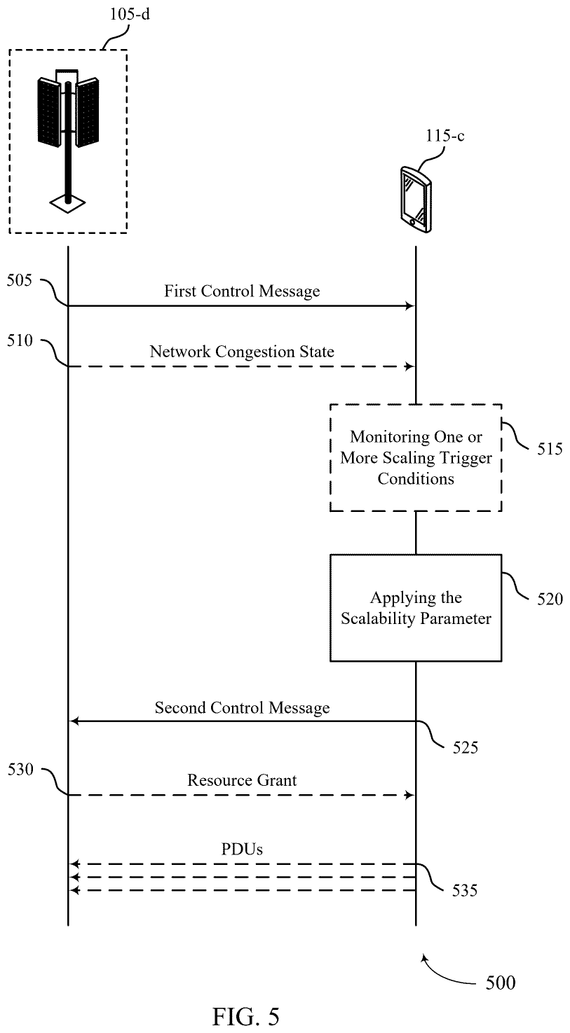

FIG. 5 shows an example of a process flow 500 that supports scalability parameters for PDU set traffic in accordance with one or more aspects of the present disclosure. In some examples, process flow 500 may implement aspects of, or be implemented by aspects of, the wireless communications system 100, the wireless communications system 200, the PDU session flow 300, or the wireless communications system 400. For example, the process flow 500 may include a network entity 105-d and a UE 115-c which may be examples of corresponding devices described with reference to FIGS. 1-4.

At 505, the UE 115-c may receive a first control message indicating a PDU set configuration for a PDU set. The PDU set configuration may indicate a parameter (e.g., latency parameters) associated with the PDU set, a scalability parameter associated with the parameter (e.g., RLC polling or status triggers and BSR retransmission timer), and a scaling trigger condition for applying the scalability parameter to the parameter. In some cases, the PDU set includes a plurality of PDUs that are each associated with a jitter metric. For example, the PDU set may be associated with an XR application as described with reference to FIG. 2.

At 510, the UE 115-c may receive an indication of a network congestion state associated with a wireless channel. The network congestion state may indicate that the scaling trigger condition is satisfied.

At 515, the UE 115-c may monitor one or more scaling trigger conditions associated with the application of the scalability parameter. In some examples, the UE 115-c may monitor an error rate associated with transmission of one or more packets. The error rate exceeding an error rate threshold may indicate that the scaling trigger condition is satisfied. In some cases, the UE 115-c may monitor one or more retransmissions of one or more packets of the PDU set. A quantity of retransmissions exceeding a retransmission threshold may indicate that the scaling trigger condition is satisfied. In some examples, the UE 115-c may monitor a KPI associated with the PDU set. The key performance indicator exceeding a key performance indicator threshold may indicate that the scaling trigger condition is satisfied. In some examples, the UE 115-c may monitor a ratio between a grant pattern and an actual data rate associated with transmission of one or more packets. The ratio exceeding a ratio threshold may indicate that the scaling trigger condition is satisfied.

At 520, the UE 115-c may apply the scalability parameter to the parameter to obtain a scaled parameter based on the scaling trigger condition being satisfied. In some cases, the scaling trigger condition may be satisfied based on a PDU set metric associated with the PDU set exceeding a PDU set threshold. In some cases, the PDU set metric may include a delay status report trigger associated with a delay budget of the PDU set, a data traffic volume associated with the PDU set, or both. For example, the UE 115-c may apply the scalability parameter to an RLC polling timer, an RLC polling trigger, an RLC reassembly timer, an RLC status prohibit timer or a MAC BSR retransmission timer.

In some cases, the UE 115-c may adjust the scalability parameter received via the first control message. The UE 115-c may apply a second scalability parameter to the parameter to obtain a scaled parameter based on the scaling trigger condition being satisfied. The second scalability parameter may be different than the scalability parameter received via the first control message. The second scalability parameter may be based on the scalability parameter received via the first control message. For example, application of the scalability parameter may be based on an output of an ML model. An input of the ML model may include the scalability parameter and an indication of channel conditions. The UE 115-c may update a value of the scalability parameter from a first value (e.g., 50%) to a second value (e.g., 47%) based on an output of the ML model.

At 525, the UE 115-c may transmit, based on the scaled parameter satisfying a threshold, a second control message associated with the PDU set. In some cases, the second control message may include a polling message associated with the PDU set, a status message associated with the PDU set, or a BSR message associated with the PUD set.

In some cases, at 530, the UE 115-c may receive, based on transmission of the second control message, a resource grant associated with the PDU set. In some cases, at 535, the UE 115-c may transmit one or more packets data units of the PDU set via a resource allocated by the resource grant.

In some cases, the UE 115-c may apply a second scalability parameter to the parameter to obtain a second scaled parameter based on a second scaling trigger condition being satisfied. The UE 115-c may transmit, based on the second scaled parameter satisfying a second threshold, a third message associated with the PDU set.

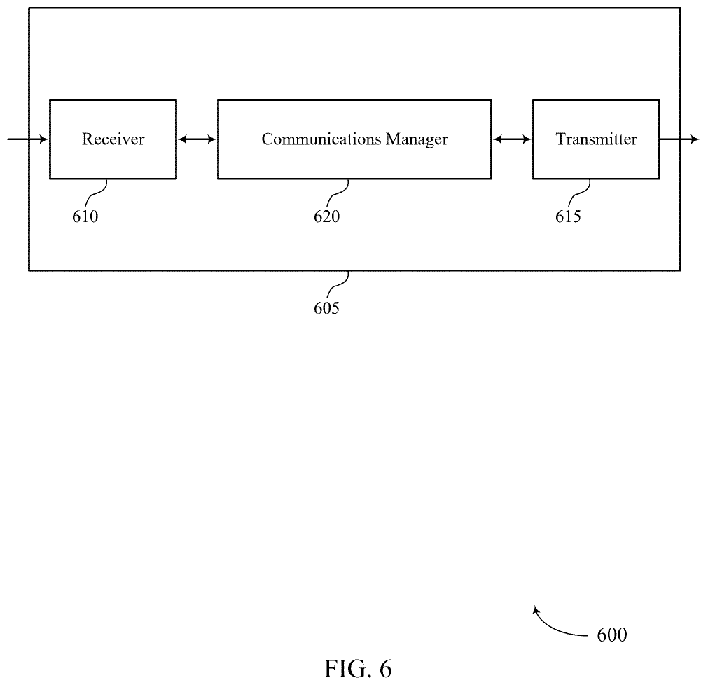

FIG. 6 shows a block diagram 600 of a device 605 that supports scalability parameters for PDU set traffic in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to scalability parameters for PDU set traffic). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to scalability parameters for PDU set traffic). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of scalability parameters for PDU set traffic as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry), code (e.g., software) executed by a processor, or any combination thereof. The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving a first message indicating a PDU set configuration for a PDU set, where the PDU set configuration indicates a parameter associated with the PDU set, a scalability parameter associated with the parameter, and a scaling trigger condition for applying the scalability parameter to the parameter. The communications manager 620 is capable of, configured to, or operable to support a means for applying the scalability parameter to the parameter to obtain a scaled parameter based on the scaling trigger condition being satisfied. The communications manager 620 is capable of, configured to, or operable to support a means for transmitting, based on the scaled parameter satisfying a threshold, a second message associated with the PDU set.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for more efficient utilization of communication resources.

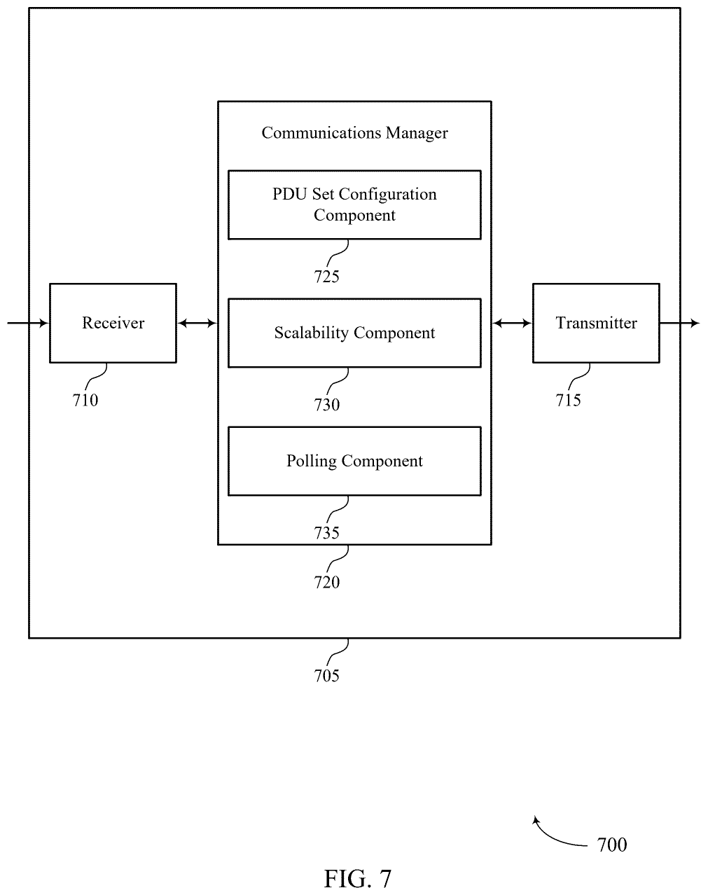

FIG. 7 shows a block diagram 700 of a device 705 that supports scalability parameters for PDU set traffic in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to scalability parameters for PDU set traffic). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to scalability parameters for PDU set traffic). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of scalability parameters for PDU set traffic as described herein. For example, the communications manager 720 may include a PDU set configuration component 725, a scalability component 730, a polling component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The PDU set configuration component 725 is capable of, configured to, or operable to support a means for receiving a first message indicating a PDU set configuration for a PDU set, where the PDU set configuration indicates a parameter associated with the PDU set, a scalability parameter associated with the parameter, and a scaling trigger condition for applying the scalability parameter to the parameter. The scalability component 730 is capable of, configured to, or operable to support a means for applying the scalability parameter to the parameter to obtain a scaled parameter based on the scaling trigger condition being satisfied. The polling component 735 is capable of, configured to, or operable to support a means for transmitting, based on the scaled parameter satisfying a threshold, a second message associated with the PDU set.

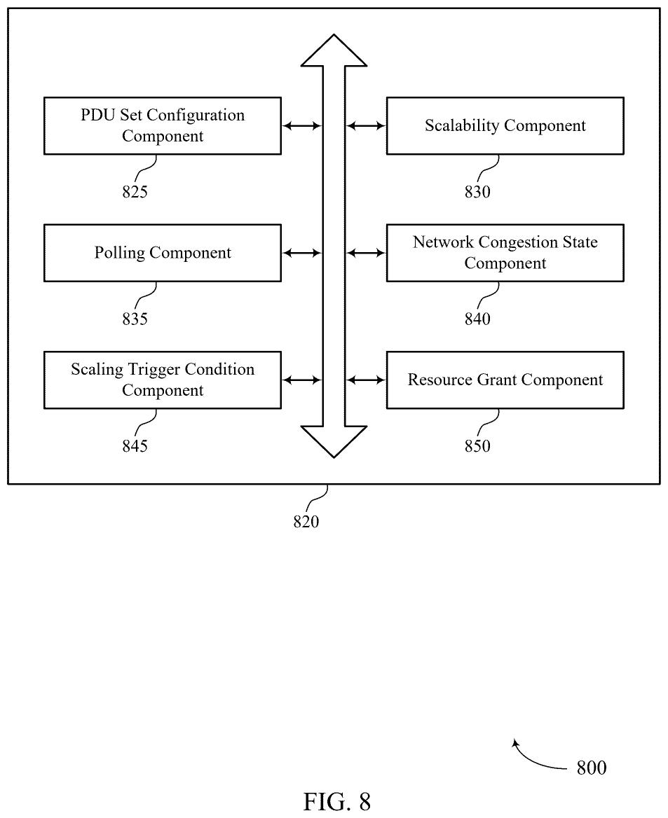

FIG. 8 shows a block diagram 800 of a communications manager 820 that supports scalability parameters for PDU set traffic in accordance with one or more aspects of the present disclosure. The communications manager 820 may be an example of aspects of a communications manager 620, a communications manager 720, or both, as described herein. The communications manager 820, or various components thereof, may be an example of means for performing various aspects of scalability parameters for PDU set traffic as described herein. For example, the communications manager 820 may include a PDU set configuration component 825, a scalability component 830, a polling component 835, a network congestion state component 840, a scaling trigger condition component 845, a resource grant component 850, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The PDU set configuration component 825 is capable of, configured to, or operable to support a means for receiving a first message indicating a PDU set configuration for a PDU set, where the PDU set configuration indicates a parameter associated with the PDU set, a scalability parameter associated with the parameter, and a scaling trigger condition for applying the scalability parameter to the parameter. The scalability component 830 is capable of, configured to, or operable to support a means for applying the scalability parameter to the parameter to obtain a scaled parameter based on the scaling trigger condition being satisfied. The polling component 835 is capable of, configured to, or operable to support a means for transmitting, based on the scaled parameter satisfying a threshold, a second message associated with the PDU set.

In some examples, the network congestion state component 840 is capable of, configured to, or operable to support a means for receiving an indication of a network congestion state associated with a wireless channel, where the network congestion state indicates that the scaling trigger condition is satisfied.

In some examples, the scaling trigger condition is satisfied based on a PDU set metric associated with the PDU set exceeding a PDU set threshold.

In some examples, the PDU set metric includes a delay status report trigger associated with a delay budget of the PDU set, a data traffic volume associated with the PDU set, or both.

In some examples, the scaling trigger condition component 845 is capable of, configured to, or operable to support a means for monitoring an error rate associated with transmission of one or more packets, where the error rate exceeding an error rate threshold indicates that the scaling trigger condition is satisfied.

In some examples, the scaling trigger condition component 845 is capable of, configured to, or operable to support a means for monitoring one or more retransmissions of one or more packets of the PDU set, where a quantity of retransmissions exceeding a retransmission threshold indicates that the scaling trigger condition is satisfied.

In some examples, the scaling trigger condition component 845 is capable of, configured to, or operable to support a means for monitoring a KPI associated with the PDU set, where the KPI exceeding a key performance indicator threshold indicates that the scaling trigger condition is satisfied.

In some examples, the scaling trigger condition component 845 is capable of, configured to, or operable to support a means for monitoring a ratio between a grant pattern and an actual data rate associated with transmission of one or more packets, where the ratio exceeding a ratio threshold indicates that the scaling trigger condition is satisfied.

In some examples, the scalability component 830 is capable of, configured to, or operable to support a means for applying a second scalability parameter to the parameter to obtain a second scaled parameter based on a second scaling trigger condition being satisfied. In some examples, the polling component 835 is capable of, configured to, or operable to support a means for transmitting, based on the second scaled parameter satisfying a second threshold, a third message associated with the PDU set or a second request message associated with the PDU set.

In some examples, the PDU set includes a set of multiple PDUs that are each associated with a jitter metric.

In some examples, application of the scalability parameter is based on an output of a ML model, and where an input of the ML model comprises the scalability parameter and an indication of one or more channel conditions.

In some examples, the resource grant component 850 is capable of, configured to, or operable to support a means for receiving, based on transmission of the second message, a resource grant associated with the PDU set. In some examples, the resource grant component 850 is capable of, configured to, or operable to support a means for transmitting one or more packets data units of the PDU set via a resource allocated by the resource grant.

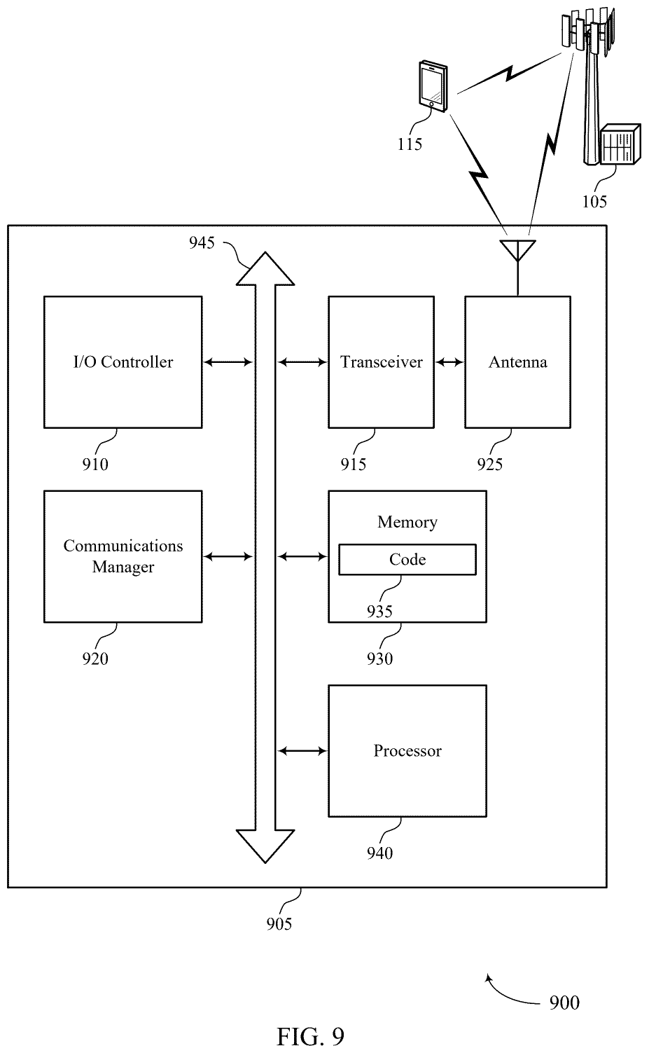

FIG. 9 shows a diagram of a system 900 including a device 905 that supports scalability parameters for PDU set traffic in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting scalability parameters for PDU set traffic). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving a first message indicating a PDU set configuration for a PDU set, where the PDU set configuration indicates a parameter associated with the PDU set, a scalability parameter associated with the parameter, and a scaling trigger condition for applying the scalability parameter to the parameter. The communications manager 920 is capable of, configured to, or operable to support a means for applying the scalability parameter to the parameter to obtain a scaled parameter based on the scaling trigger condition being satisfied. The communications manager 920 is capable of, configured to, or operable to support a means for transmitting, based on the scaled parameter satisfying a threshold, a second message associated with the PDU set.

By including or configuring the communications manager 920 in accordance with examples as described herein, the device 905 may support techniques for improved communication reliability, reduced latency, more efficient utilization of communication resources, or improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of scalability parameters for PDU set traffic as described herein, or the at least one processor 940 and the at least one memory 930 may be otherwise configured to, individually or collectively, perform or support such operations.

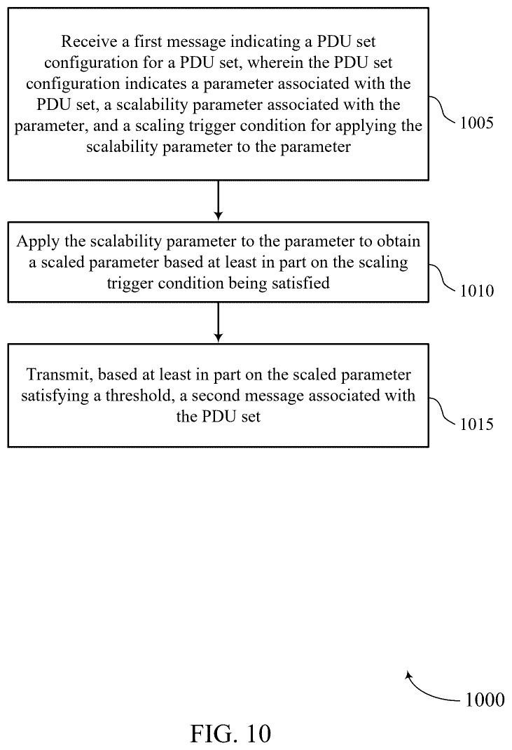

FIG. 10 shows a flowchart illustrating a method 1000 that supports scalability parameters for PDU set traffic in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving a first message indicating a PDU set configuration for a PDU set, wherein the PDU set configuration indicates a parameter associated with the PDU set, a scalability parameter associated with the parameter, and a scaling trigger condition for applying the scalability parameter to the parameter. The operations of 1005 may be performed in accordance with examples as disclosed herein. In some examples, aspects of the operations of 1005 may be performed by a PDU set configuration component 825 as described with reference to FIG. 8.

At 1010, the method may include applying the scalability parameter to the parameter to obtain a scaled parameter based at least in part on the scaling trigger condition being satisfied. The operations of 1010 may be performed in accordance with examples as disclosed herein. In some examples, aspects of the operations of 1010 may be performed by a scalability component 830 as described with reference to FIG. 8.

At 1015, the method may include transmitting, based at least in part on the scaled parameter satisfying a threshold, a second message associated with the PDU set. The operations of 1015 may be performed in accordance with examples as disclosed herein. In some examples, aspects of the operations of 1015 may be performed by a polling component 835 as described with reference to FIG. 8.

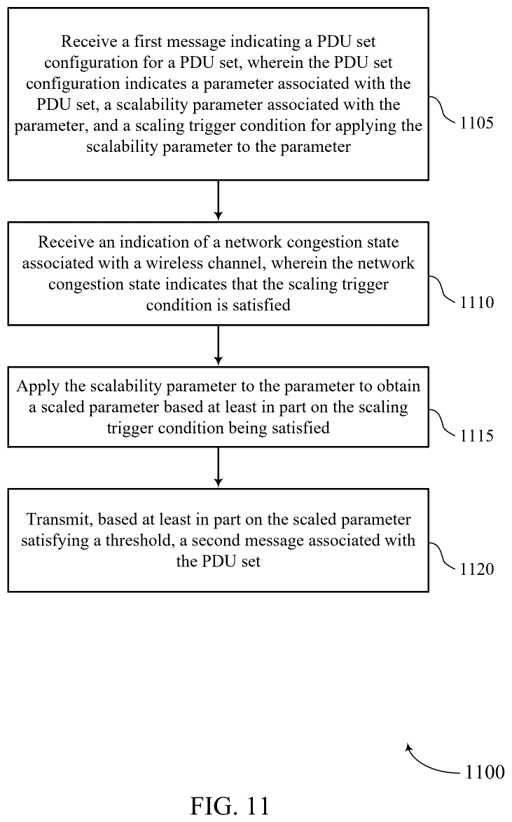

FIG. 11 shows a flowchart illustrating a method 1100 that supports scalability parameters for PDU set traffic in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include receiving a first message indicating a PDU set configuration for a PDU set, wherein the PDU set configuration indicates a parameter associated with the PDU set, a scalability parameter associated with the parameter, and a scaling trigger condition for applying the scalability parameter to the parameter. The operations of 1105 may be performed in accordance with examples as disclosed herein. In some examples, aspects of the operations of 1105 may be performed by a PDU set configuration component 825 as described with reference to FIG. 8.

At 1110, the method may include receiving an indication of a network congestion state associated with a wireless channel, wherein the network congestion state indicates that the scaling trigger condition is satisfied. The operations of 1110 may be performed in accordance with examples as disclosed herein. In some examples, aspects of the operations of 1110 may be performed by a network congestion state component 840 as described with reference to FIG. 8.

At 1115, the method may include applying the scalability parameter to the parameter to obtain a scaled parameter based at least in part on the scaling trigger condition being satisfied. The operations of 1115 may be performed in accordance with examples as disclosed herein. In some examples, aspects of the operations of 1115 may be performed by a scalability component 830 as described with reference to FIG. 8.

At 1120, the method may include transmitting, based at least in part on the scaled parameter satisfying a threshold, a second message associated with the PDU set. The operations of 1120 may be performed in accordance with examples as disclosed herein. In some examples, aspects of the operations of 1120 may be performed by a polling component 835 as described with reference to FIG. 8.

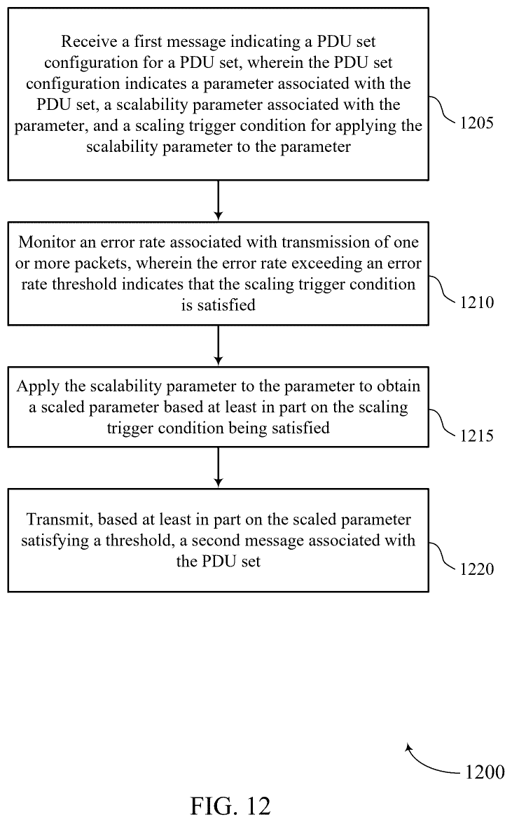

FIG. 12 shows a flowchart illustrating a method 1200 that supports scalability parameters for PDU set traffic in accordance with one or more aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1205, the method may include receiving a first message indicating a PDU set configuration for a PDU set, wherein the PDU set configuration indicates a parameter associated with the PDU set, a scalability parameter associated with the parameter, and a scaling trigger condition for applying the scalability parameter to the parameter. The operations of 1205 may be performed in accordance with examples as disclosed herein. In some examples, aspects of the operations of 1205 may be performed by a PDU set configuration component 825 as described with reference to FIG. 8.

At 1210, the method may include monitoring an error rate associated with transmission of one or more packets, wherein the error rate exceeding an error rate threshold indicates that the scaling trigger condition is satisfied. The operations of 1210 may be performed in accordance with examples as disclosed herein. In some examples, aspects of the operations of 1210 may be performed by a scaling trigger condition component 845 as described with reference to FIG. 8.

At 1215, the method may include applying the scalability parameter to the parameter to obtain a scaled parameter based at least in part on the scaling trigger condition being satisfied. The operations of 1215 may be performed in accordance with examples as disclosed herein. In some examples, aspects of the operations of 1215 may be performed by a scalability component 830 as described with reference to FIG. 8.

At 1220, the method may include transmitting, based at least in part on the scaled parameter satisfying a threshold, a second message associated with the PDU set. The operations of 1220 may be performed in accordance with examples as disclosed herein. In some examples, aspects of the operations of 1220 may be performed by a polling component 835 as described with reference to FIG. 8.

The following provides an overview of aspects of the present disclosure:

Aspect 1: A method for wireless communications at a UE, comprising: receiving a first message indicating a PDU set configuration for a PDU set, wherein the PDU set configuration indicates a parameter associated with the PDU set, a scalability parameter associated with the parameter, and a scaling trigger condition for applying the scalability parameter to the parameter; applying the scalability parameter to the parameter to obtain a scaled parameter based at least in part on the scaling trigger condition being satisfied; and transmitting, based at least in part on the scaled parameter satisfying a threshold, a second message associated with the PDU set.

Aspect 2: The method of aspect 1, further comprising: receiving an indication of a network congestion state associated with a wireless channel, wherein the network congestion state indicates that the scaling trigger condition is satisfied.

Aspect 3: The method of any of aspects 1 through 2, wherein the scaling trigger condition is satisfied based at least in part on a PDU set metric associated with the PDU set exceeding a PDU set threshold.

Aspect 4: The method of aspect 3, wherein the PDU set metric comprises a delay status report trigger associated with a delay budget of the PDU set, a data traffic volume associated with the PDU set, or both.

Aspect 5: The method of any of aspects 1 through 4, further comprising: monitoring an error rate associated with transmission of one or more packets, wherein the error rate exceeding an error rate threshold indicates that the scaling trigger condition is satisfied.

Aspect 6: The method of any of aspects 1 through 5, further comprising: monitoring one or more retransmissions of one or more packets of the PDU set, wherein a quantity of retransmissions exceeding a retransmission threshold indicates that the scaling trigger condition is satisfied.

Aspect 7: The method of any of aspects 1 through 6, further comprising: applying a second scalability parameter to the parameter to obtain a second scaled parameter based at least in part on a second scaling trigger condition being satisfied; and transmitting, based at least in part on the second scaled parameter satisfying a second threshold, a third message associated with the PDU set.

Aspect 8: The method of any of aspects 1 through 7, wherein the PDU set comprises a plurality of PDUs that are each associated with a jitter metric.

Aspect 9: The method of any of aspects 1 through 8, further comprising: receiving, based at least in part on transmission of the second message, a resource grant associated with the PDU set; and transmitting one or more packets data units of the PDU set via a resource allocated by the resource grant.

Aspect 10: The method of any of aspects 1 through 9, further comprising: monitoring a KPI associated with the PDU set, wherein the KPI exceeding a KPI threshold indicates that the scaling trigger condition is satisfied.

Aspect 11: The method of any of aspects 1 through 10, further comprising: monitor a ratio between a grant pattern and an actual data rate associated with transmission of one or more packets, wherein the ratio exceeding a ratio threshold indicates that the scaling trigger condition is satisfied.

Aspect 12: The method of any of aspects 1 through 11, wherein application of the scalability parameter is based at least in part on an output of a ML model, and wherein an input of the ML model comprises the scalability parameter and an indication of one or more channel conditions.

Aspect 13: The method of any of aspects 1 through 12, wherein the second message comprises a polling message associated with the PDU set, a status message associated with the PDU set, or a buffer status request message associated with the PDU set.

Aspect 14: A UE for wireless communications, comprising one or more memories storing processor-executable code, and one or more processors coupled with (e.g., operatively, communicatively, functionally, electronically, or electrically) the one or more memories and individually or collectively operable to execute the code (e.g., directly, indirectly, after pre-processing, without pre-processing) to cause the UE to perform a method of any of aspects 1 through 13.

Aspect 15: A UE for wireless communications, comprising at least one means for performing a method of any of aspects 1 through 13.

Aspect 16: A non-transitory computer-readable medium storing code for wireless communications, the code comprising instructions executable by one or more processors (e.g., directly, indirectly, after pre-processing, without pre-processing) to perform a method of any of aspects 1 through 13.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, a NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a first message indicating a packet data unit set configuration for a packet data unit set, wherein the packet data unit set configuration indicates a parameter associated with the packet data unit set, a scalability parameter associated with the parameter, and a scaling trigger condition for applying the scalability parameter to the parameter;
apply the scalability parameter to the parameter to obtain a scaled parameter based at least in part on the scaling trigger condition being satisfied; and
transmit, based at least in part on the scaled parameter satisfying a threshold, a second message associated with the packet data unit set.

2. The UE of claim 1, wherein the one or more processors are individually or collectively further operable to execute the code to cause the UE to:
receive an indication of a network congestion state associated with a wireless channel, wherein the network congestion state indicates that the scaling trigger condition is satisfied.

3. The UE of claim 1, wherein the scaling trigger condition is satisfied based at least in part on a packet data unit set metric associated with the packet data unit set exceeding a packet data unit set threshold.

4. The UE of claim 3, wherein the packet data unit set metric comprises a delay status report trigger associated with a delay budget of the packet data unit set, a data traffic volume associated with the packet data unit set, or both.

5. The UE of claim 1, wherein the one or more processors are individually or collectively further operable to execute the code to cause the UE to:
monitor an error rate associated with transmission of one or more packets, wherein the error rate exceeding an error rate threshold indicates that the scaling trigger condition is satisfied.

6. The UE of claim 1, wherein the one or more processors are individually or collectively further operable to execute the code to cause the UE to:
monitor one or more retransmissions of one or more packets of the packet data unit set, wherein a quantity of retransmissions exceeding a retransmission threshold indicates that the scaling trigger condition is satisfied.

7. The UE of claim 1, wherein the one or more processors are individually or collectively further operable to execute the code to cause the UE to:
apply a second scalability parameter to the parameter to obtain a second scaled parameter based at least in part on a second scaling trigger condition being satisfied; and
transmit, based at least in part on the second scaled parameter satisfying a second threshold, a third message associated with the packet data unit set.

8. The UE of claim 1, wherein the packet data unit set comprises a plurality of packet data units that are each associated with a jitter metric.

9. The UE of claim 1, wherein the one or more processors are individually or collectively further operable to execute the code to cause the UE to:
receive, based at least in part on transmission of the second message, a resource grant associated with the packet data unit set; and
transmit one or more packets data units of the packet data unit set via a resource allocated by the resource grant.

10. The UE of claim 1, wherein the one or more processors are individually or collectively further operable to execute the code to cause the UE to:
monitor a key performance indicator associated with the packet data unit set, wherein the key performance indicator exceeding a key performance indicator threshold indicates that the scaling trigger condition is satisfied.

11. The UE of claim 1, wherein the one or more processors are individually or collectively further operable to execute the code to cause the UE to:
monitor a ratio between a grant pattern and an actual data rate associated with transmission of one or more packets, wherein the ratio exceeding a ratio threshold indicates that the scaling trigger condition is satisfied.

12. The UE of claim 1, wherein application of the scalability parameter is based at least in part on an output of a machine learning model, and wherein an input of the machine learning model comprises the scalability parameter and an indication of one or more channel conditions.

13. The UE of claim 1, wherein the second message comprises a polling message associated with the packet data unit set, a status message associated with the packet data unit set, or a buffer status request message associated with the packet data unit set.

14. A method for wireless communications at a user equipment (UE), comprising:
receiving a first message indicating a packet data unit set configuration for a packet data unit set, wherein the packet data unit set configuration indicates a parameter associated with the packet data unit set, a scalability parameter associated with the parameter, and a scaling trigger condition for applying the scalability parameter to the parameter;
applying the scalability parameter to the parameter to obtain a scaled parameter based at least in part on the scaling trigger condition being satisfied; and
transmitting, based at least in part on the scaled parameter satisfying a threshold, a second message associated with the packet data unit set.

15. The method of claim 14, further comprising:
receiving an indication of a network congestion state associated with a wireless channel, wherein the network congestion state indicates that the scaling trigger condition is satisfied.

16. The method of claim 14, wherein the scaling trigger condition is satisfied based at least in part on a packet data unit set metric associated with the packet data unit set exceeding a packet data unit set threshold.

17. The method of claim 16, wherein the packet data unit set metric comprises a delay status report trigger associated with a delay budget of the packet data unit set, a data traffic volume associated with the packet data unit set, or both.

18. The method of claim 14, further comprising:
monitoring an error rate associated with transmission of one or more packets, wherein the error rate exceeding an error rate threshold indicates that the scaling trigger condition is satisfied.

19. The method of claim 14, further comprising:
monitoring one or more retransmissions of one or more packets of the packet data unit set, wherein a quantity of retransmissions exceeding a retransmission threshold indicates that the scaling trigger condition is satisfied.

20. A non-transitory computer-readable medium storing code for wireless communication, the code comprising instructions executable by at least one processor to:
receive a first message indicating a packet data unit set configuration for a packet data unit set, wherein the packet data unit set configuration indicates a parameter associated with the packet data unit set, a scalability parameter associated with the parameter, and a scaling trigger condition for applying the scalability parameter to the parameter;
apply the scalability parameter to the parameter to obtain a scaled parameter based at least in part on the scaling trigger condition being satisfied; and
transmit, based at least in part on the scaled parameter satisfying a threshold, a second message associated with the packet data unit set.
